(19) United States
(12) Patent Application Publication
(10) Pub. No.: US 2007/0147089 A1
(43) Pub. Date: Jun. 28, 2007

(54) Backlight module and lcd having same

(75) Inventors: Wen-Bin Lin, Shenzhen (CN); Na Wei, Shenzhen (CN); Chih-Hung Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/645,422

(22) Filed: Dec. 26, 2006

(30) Foreign Application Priority Data
Dec. 23, 2005 (TW) 94146275

(51) Int. Cl. F21V 7/04

(52) U.S. Cl. 362/616

(57) ABSTRACT

An exemplary backlight module (300) has at least two light guide plates (322, 323) spacing a predetermined distance and at least one light source (324), the at least two light guide plates each having a light incident surface (31, 32). The at least one light source is disposed between the at least two light incident surfaces.

### FIELD OF THE INVENTION

The present invention relates to backlight modules and liquid crystal displays, particularly to backlight modules and liquid crystal displays having at least one light source disposed between at least two light guide plate.

### GENERAL BACKGROUND

A typical liquid crystal display is capable of displaying a clear and sharp image through millions of pixels that make up the complete image. The liquid crystal display has thus been applied to various electronic equipment in which messages or pictures need to be displayed, such as mobile phones and notebook computers. However, liquid crystals in the liquid crystal display do not themselves emit light. Rather, the liquid crystals have to be lit up by a light source so as to clearly and sharply display text and images. The light source may be ambient light, or a backlight module attached to the liquid crystal display.

Referring to FIG. 6, a typical liquid crystal display 100 has a liquid crystal panel 110 and a backlight module 120 set at a rear side of the liquid crystal panel 110. The backlight module 120 generally includes a light source 124, a reflective plate 123, a light guide plate 122 and a diffusing plate 121. The reflective plate 123, the light guide plate 122, and the diffusing plate 121 are arranged in that order from bottom to top. The light source 11 is positioned adjacent to a side surface 11 of the light guide plate 122.

When a voltage is provided to the light source 124, light beams from the light source 124 directly enter the light guide plate 122 or are reflected into the light guide plate 122 by a reflector 125. The light guide plate 122 and the reflector plate 123 cooperate to change the transmitting direction of the light beams and guide the light beams to enter into the diff-using plate 121. The light beams are diffused to be uniform, and then enter the liquid crystal panel 110.

However, the liquid crystal display 100 has only one light source 124 which faces only one side surface for guiding the light beams into the light guide plate 122. Thus, the intensity of the light beams guided into the light guide plate 122 is low. In addition, light beams in the light guide plate 122 produces times reflection by the reflector plate 123 before they are guided into the liquid crystal panel 110, which the intensity of the light beams are wasted. Thus, the liquid crystal display 100 has a low light beams utilization ratio.

Referring to FIG. 7, another typical liquid crystal display 200 is shown. The liquid crystal display 200 has a liquid crystal panel 210 and a backlight module 220. The backlight module 220 has a diffuser 221, a light guide plate 222, a plurality of light sources 223 and a reflector plate 224. The light guide plate 222 has a light emitting surface 21 and a bottom surface 22 opposite to the light emitting surface 21. The plurality of light sources 223 is cold cathode fluorescent lamp (CCFL).

When a voltage is provided on the liquid crystal display 200, a part of light beams from the light sources 223 directly enter into the light guide plate 222 through the bottom surface 22, and another part of light beams are reflected by the reflector plate 224 into the light guide plate 222 through the bottom surface 22. After that, light beams are diffused by the diffuser 221 and uniformly transmit into the liquid crystal panel 210.

However, the plurality of light sources 223 omnidirectional emit light beams. Thus, some light beams emitted can not be utilized by the liquid crystal panel 210. Therefore, the liquid crystal display 200 has a low light beams utilization ratio.

Therefore, a new backlight module and a corresponding liquid crystal display that can overcome the above-described problems are desired.

### SUMMARY

In a preferred embodiment, an exemplary backlight module has at least two light guide plates spacing a predetermined distance and at least one light source, the at least two light guide plates each having a light incident surface. The at least one light source is disposed between the at least two light incident surfaces.

In another preferred embodiment, an exemplary liquid crystal display has a liquid crystal panel and a backlight module disposed at a rear side of the liquid crystal panel. The backlight module has at least two light guide plates spacing a predetermined distance and at least one light source, the at least two light guide plates each having a light incident surface. The at least one light source is disposed between the at least two light incident surfaces.

Other advantages and novel features will become more apparent from the following detailed description when taken in conjunction with the accompanying drawings. All the views in the drawings are schematic.

### BRIEF DESCRIPTION OF THE DRAWINGS

FIG. 1 is a schematic, exploded side view of a liquid crystal display according a first embodiment of the present invention.

FIG. 2 is a schematic, exploded side view of a liquid crystal display according a second embodiment of the present invention.

FIG. 3 is a schematic, exploded side view of a liquid crystal display according a third embodiment of the present invention.

FIG. 4 is a schematic, exploded side view of a liquid crystal display according a fourth embodiment of the present invention.

FIG. 5 is a schematic, exploded side view of a liquid crystal display according a fifth embodiment of the present invention.

FIG. 6 is a schematic, side view of a conventional liquid crystal display.

FIG. 7 is a schematic, side view of an another conventional liquid crystal display.

### DETAILED DESCRIPTION OF PREFERRED EMBODIMENTS

Referring to FIG. 1, a liquid crystal display according to a first embodiment of the present invention. The liquid crystal display 300 has a liquid crystal panel 310 and a backlight module 320 disposed at a rear side of the liquid crystal panel 310. The backlight module 320 has a diffuser 321, a first light guide plate 322, a second light guide plate 323, a light source 324 and a reflector 325. The first and the second light guide plates 322, 323 are disposed side by side, spacing a predetermined distance, between the diffuser 321 and the reflector 325. The first light guide plate 322 has a first light incident surface 31, the second light guide plate 323 has a second light incident surface 32, the second light incident surface 32 being opposite to the first light incident surface 31. The light source 324 is a CCFL, which is disposed between the first and the second light incident surfaces 31, 32.

The diffuser 321 covers the whole top surfaces (not labeled) of the first and the second light guide plates 322, 323, which have a plurality of diffusing particles irregularly distributed therein. The diff-using particles corresponding to the light source 324 has a smaller diameter than the diffusing particles corresponding to the first and the second light guide plates 322, 323.

When a voltage is provided to the light source 324, a large part of light beams are guided into the first and second light guide plates 322, 323 through a first and a second light incident surfaces 31, 32. The first and second light guide plate 322, 323 cooperating with the reflector 325 transfer the direction of the light beams from the light source 324, perpendicular emitting to the diffuser 321. After that, uniform light beams diffused by the diffuser 321 propagate into the liquid crystal panel 310.

Because part light beams from the light source 324 can be utilized by the first and the second light guide plates 322, 323 at two sides of the light source 324, and part light beams from the light source 324 can be directly sent to the diffuser 321, and then be provided to the liquid crystal panel 310. Therefore, the liquid crystal display 310 has a high luminance and high light beams utilization ratio.

In addition, there can be a plurality of light guide plates and a plurality of light sources. The plurality of light sources is respectively disposed at two adjacent light guide plates.

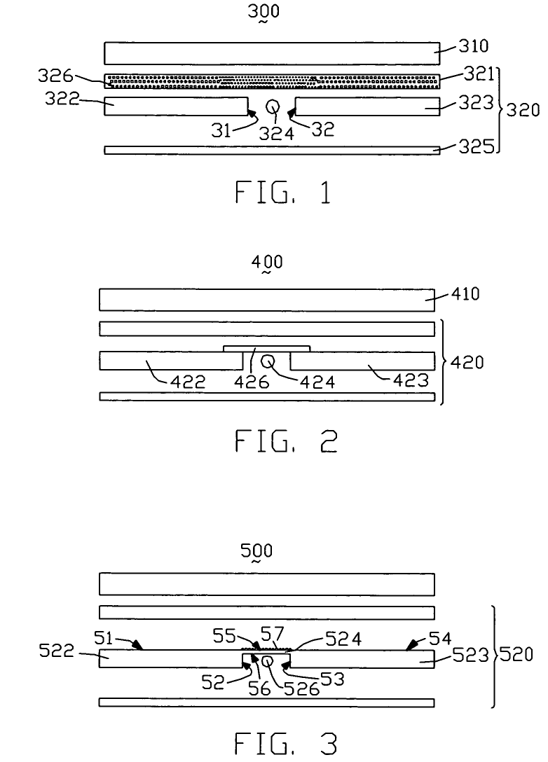

Referring to FIG. 2, a liquid crystal display according to a second embodiment of the present invention is shown. The liquid crystal display 400 has a structure same to that of the liquid crystal display 300 except that a backlight module 420 further has a diffuser 426, which is disposed on two adjacent ends of the first and the second light guide plate 422, 423, covering the light source 424. The diffuser 426 can further diffuse the light beams which are directly transmitted toward the liquid crystal panel 410.

In an alternative embodiments, the number of the first and the second light guide plates 422, 423 can be more than one and the number of the light source 424 and the diffuser 426 also can be more than one, i.e. there are a plurality of first and second light guide plates 422, 423, which cooperates with a plurality of light sources 424 and a plurality of diffusers 426, each light source 424 being disposed between two adjacent first and second light guide plates 422, 423, and each diffuser 426 being corresponding to the light source 424.

Referring to FIG. 3, a liquid crystal display according to a third embodiment of the present invention is shown. The liquid crystal display 500 has a structure same to that of the liquid crystal display 300 except that a backlight module 520 further has a third light guide plate 524 used for connecting with a first and a second light guide plates 522, 523. The third light guide plate 524 has a thinner thickness than that of the first and the second light guide plates 522, 523. The third light guide plate 524 has a light incident surface 56 and a light emitting surface 55, the light emitting surface 55 being coplanar with two light emitting surfaces 51, 54 of the first and the second light guide plates 522, 523. In addition, the light emitting surface 55 has a diffusing structure 57 formed thereon, which has a plurality of diffusing dots. The light incident surface 56 of the third light guide plate 524 and two light incident surfaces 52, 53 of the first and the second light guide plates 522, 523 define a space for accommodating a light source 526.

Light beams from the light source 526 respectively enter into the first, the second and the third light guide plates 522, 523, 524 through the three light incident surfaces 52, 53, 56. Light beams into the third light guide plate 524 are diff-used by the diffusing structure 57, which the diffusing structure 57 compensates the thinner thickness of the third light guide plate 524 to preventing the liquid crystal display 500 from bright lines at a region corresponding to the third light guide plate 524.

In alternate embodiment, the number of the first, the second light and the third guide plates 522, 523, 524 can be more than one and the number of the light source 526 also can be more than one, i.e. there are a plurality of first and second light guide plates 522, 523, which cooperates with a plurality of light sources 526, each light source 526 being disposed between two adjacent first and second light guide plates 522, 523. In addition, the diffusing structure 57 can also be a plurality of concave grooves, convex knobs or diffusing particles, which can be formed at the three light emitting surfaces 51, 54, 55.

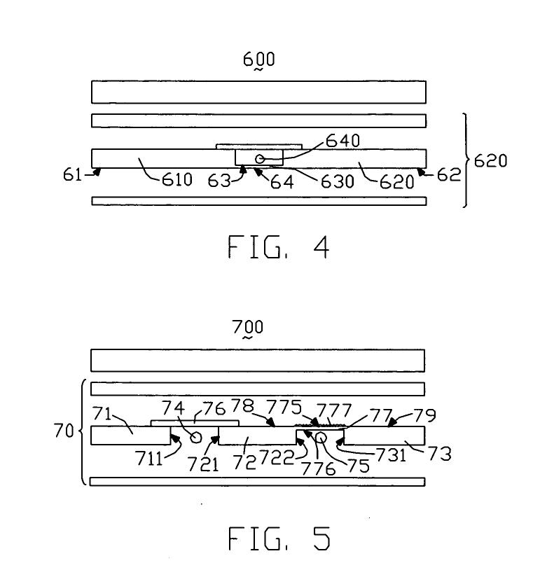

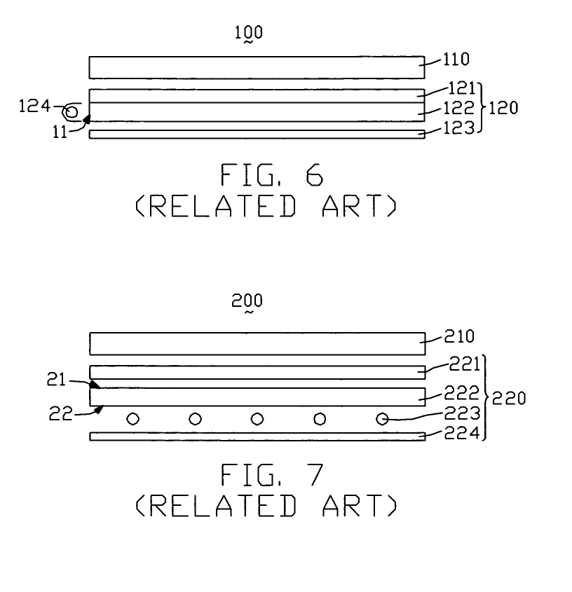

Referring to FIG. 4, a liquid crystal display according to a fourth embodiment of the present invention is shown. The liquid crystal display 600 has a structure same to that of the liquid crystal display 400 except that a backlight module 620 further has a third light guide plate 630, used for connecting with a first and a second light guide plates 610, 620. The third light guide plate 630 has a thinner thickness than that of the first and the second light guide plates 610, 620. The third light guide plate 630 has a bottom surface 63 and a light emitting surface 64, the bottom surface 63 being coplanar with two bottom surfaces 61, 62 of the first and the second light guide plates 610,620. The light emitting surface 63 of the third light guide plate 630 and two light incident surfaces (not labeled) of the first and the second light guide plates 610, 620 define a space for accommodating a light source 640.

Referring to FIG. 5, a liquid crystal display according to a fifth embodiment of the present invention is shown. The liquid crystal display 700 has a structure same to that of the two liquid crystal displays 400, 500. A backlight module 70 of the liquid crystal display 700 has a diffuser 76, a first light guide plate 71, a second light guide plate 72, a third light guide plate 73, a first light source 74, a second light source 75 and a fourth light guide plate 77.

The first, the second and the third light guide plates 71, 72, 73 are disposed side by side, spacing a predetermined distance. The first light guide plate 71 has a first light incident surface 711, the second light guide plate 72 has two second light incident surface 721, 722, the third light guide plate 73 has a third light incident surface 731, the two second light incident surfaces 721, 722 being respectively opposite to the first light incident surface 711, the third light incident surface 731. The diffuser 76 is disposed on two adjacent ends of the first and the second light guide plates 71, 72, wherein the diffuser 76, the first and the second light incident surfaces 721, 722 define a space for accommodating the first light source 74. The fourth light guide plate 77 connects the second and the third light guide plates 72, 73, wherein a light incident surface 776 of the fourth light guide plate 77, the second and the third light guide plates 722, 731 define a space for accommodating the second light source 75.

Because the first and the second light sources 74, 75 are respectively disposed between the first, the second and the third light guide plates 71, 72, 73. light beams from the first and the second light sources 74, 75 are respectively guided by the first, the second and the third light guide plates 71, 72, 73. Thus, the light beams can be effectively utilized by the first, the second and the third light guide plates 71, 72, 73. In addition, the diffuser 76 and the diffusing structure 777 can respectively diffuse light beams directly from the first and the second light sources 74, 75, which can prevent the liquid crystal display from producing bright lines at a region corresponding to the first and the second light sources 74, 75.

Comparing to typical liquid crystal displays 100, 200, the liquid crystal displays 300, 400, 500, 600, 700 utilize at least two light guide plates spaced disposed for defining a space to accommodate at least one light source. Thus, the areas of the light incident surfaces are increased, and the light beams from the at least one light source can be largely enter into the light guide plate. Therefore, the liquid crystal displays 300, 400, 500, 600, 700 have a high light utilization ratio.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
at least two light guide plates spacing a predetermined distance and at least one light source, the at least two light guide plates each having a light incident surface;
wherein the at least one light source is disposed between the at least two light incident surfaces.

2. The backlight module as claimed in claim 1, wherein each light guide plate further has a light emitting surface and a bottom surface opposite to the light emitting surface, which connect with the light incident surface respectively.

3. The backlight module as claimed in claim 2, further comprising at least one sub light guide plate connecting the at least two light guide plates, each having a light incident surface facing one light source, and a light emitting surface opposite to the light incident surface.

4. The backlight module as claimed in claim 3, wherein the sub light guide plate has a light incident surface which is coplanar with the light incident surfaces of the at least two light guide plates.

5. The backlight module as claimed in claim 3, wherein the sub light guide plate further has a diffusing structure formed on a light emitting surface thereon.

6. The backlight module as claimed in claim 3, wherein the diffusing structure is one of diffusing dots, concave grooves, convex knobs and diffusing particles.

7. The backlight module as claimed in claim 1, further comprising a diffuser covering two ends of the at least two light guide plates, facing the at least one light source.

8. The backlight module as claimed in claim 1, further comprising a diffuser covering the at least two light guide plates.

9. A liquid crystal display comprising:
a liquid crystal panel and a backlight module disposed at a rear side of the liquid crystal panel, the backlight module comprising:
at least two light guide plates spacing a predetermined distance and at least one light source, the at least two light guide plates each having a light incident surface;
wherein the at least one light source is disposed between the at least two light incident surfaces.

10. The liquid crystal display as claimed in claim 1, wherein each light guide plate further has a light emitting surface and a bottom surface opposite to the light emitting surface, which connect with the light incident surface respectively.

11. The liquid crystal display as claimed in claim 2, further comprising at least one sub light guide plate connecting the at least two light guide plates, each having a light incident surface facing one light source, and a light emitting surface opposite to the light incident surface.

12. The liquid crystal display as claimed in claim 3, wherein the sub light guide plate has a light incident surface which is coplanar with the light incident surfaces of the at least two light guide plates.

13. The liquid crystal display as claimed in claim 3, wherein the sub light guide plate further has a diffusing structure formed on a light emitting surface thereon.

14. The liquid crystal display as claimed in claim 3, wherein the diffusing structure is one of diffusing dots, concave grooves, convex knobs and diffusing particles.

15. The liquid crystal display as claimed in claim 3, further comprising a diffuser covering two ends of the at least two light guide plates, facing the at least one light source.

16. The liquid crystal display as claimed in claim 3, further comprising a diffuser covering the at least two light guide plates.

17. A backlight module comprising:
at least two light guide plate sections spaced from each other in a coplanar manner along a horizontal direction and respectively having thereon light incident surfaces facing to each other; and
at least one light source located between the at least two light incident surfaces essentially in said coplanar manner.

18. The backlight module as claimed in claim 17, wherein a diffusion layer located above said light source in a vertical direction perpendicular to said horizontal direction
